(19) United States
(12) Patent Application Publication
(10) Pub. No.: US 2026/0260980 A1
(43) Pub. Date: Sep. 3, 2026

(54) SECONDARY BATTERY AND SECONDARY BATTERY MODULE

(71) Applicant: KABUSHIKI KAISHA TOSHIBA, Kawasaki-shi (JP)

(72) Inventors: Kosuke MIZOGUCHI, Inagi Tokyo (JP); Shusuke MORITA, Yokohama Kanagawa (JP)

(73) Assignee: KABUSHIKI KAISHA TOSHIBA, Kawasaki-shi (JP)

(21) Appl. No.: 19/653,201

(22) Filed: Apr. 21, 2026

Related U.S. Application Data
(63) Continuation of application No. PCT/JP2025/010601, filed on Mar. 19, 2025.

(30) Foreign Application Priority Data
Nov. 28, 2024 (JP) 2024-207326

(51) Int. Cl. H01M 50/169; H01M 50/103; H01M 50/507; H01M 50/55

(52) U.S. Cl. CPC H01M 50/169; H01M 50/103; H01M 50/507; H01M 50/55

(57) ABSTRACT

According to one embodiment, a secondary battery includes an outer case having a bottom wall, a side wall, and an aperture portion, an electrode assembly housed in the outer case, and a lid member fixed to the aperture portion of the outer case by a welded portion. The welded portion includes, in a cross section along a housing direction of the electrode assembly, a first connecting portion that connects the side wall and a bottom surface of the lid member inside the outer case. The first connecting portion is concave toward an outer case outside at the welded portion.

### CROSS-REFERENCE TO RELATED APPLICATIONS

This application is a Continuation application of PCT Application No. PCT/JP2025/010601, filed Mar. 19, 2025 and based upon and claiming the benefit of priority from prior Japanese Patent Application No. 2024-207326, filed Nov. 28, 2024, the entire contents of all of which are incorporated herein by reference.

### FIELD

Embodiments described herein relate generally to a secondary battery and a secondary battery module.

### BACKGROUND

In recent years, secondary batteries such as lead-acid batteries and nickel-metal hydride batteries have been used as power sources for electric vehicles, hybrid vehicles, electric motorcycles, forklifts, and the like. Recently, development aimed at adopting lithium-ion secondary batteries having high energy density has been actively conducted, while taking into consideration long service life and safety.

As a form of a typical lithium-ion secondary battery (hereinafter referred to as a secondary battery), a secondary battery includes an outer case having an aperture portion, an electrode assembly housed in the outer case, and a lid member provided at the aperture portion of the outer case. The aperture portion of the outer case and the lid member are welded together in a closely contacted state. In such a secondary battery, the welded portion may form an acute boundary portion directed toward the outside of the outer case. Further, gas may be generated from the electrode assembly during charging and discharging and accumulate inside the secondary battery, increasing internal pressure of the secondary battery. Under such conditions, formation of the acute boundary portion may reduce welding strength at the welded portion.

### BRIEF DESCRIPTION OF THE DRAWINGS

FIG. 1 is a schematic perspective view showing a secondary battery of the first embodiment.

FIG. 2 is a partial cross-sectional view showing a YZ plane including a welded portion of the secondary battery of the first embodiment along line I-I in FIG. 1.

FIG. 3 is a partial cross-sectional view showing an angle formed between an interface of a side wall of an outer case and an interface of a lid member in FIG. 2.

FIG. 4 is a partial cross-sectional view showing a YZ plane including a welded portion of the secondary battery 1 of a modified example of the first embodiment along line I-I in FIG. 1.

FIG. 5 is a schematic perspective view showing a secondary battery module of the second embodiment.

### DETAILED DESCRIPTION

The present invention aims to provide a secondary battery and a secondary battery module having excellent welding strength between an aperture portion of an outer case and a lid member.

In general, according to one embodiment, a secondary battery includes an outer case having a bottom wall, a side wall, and an aperture portion, an electrode assembly housed in the outer case, and a lid member fixed to the aperture portion of the outer case by a welded portion. The welded portion includes, in a cross section along a housing direction of the electrode assembly, a first connecting portion that connects the side wall and a bottom surface of the lid member inside the outer case. The first connecting portion is concave toward an outer case outside at the welded portion.

The following describes a secondary battery and a secondary battery module of embodiments with reference to figures.

### First Embodiment

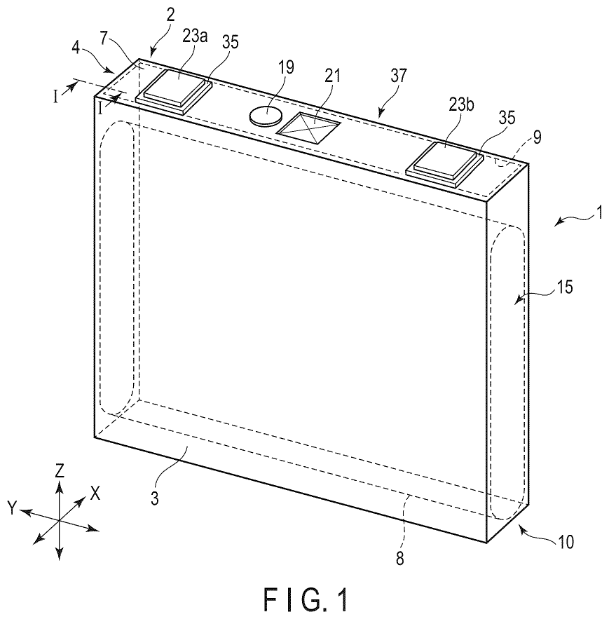

The following describes a secondary battery 1 of the first embodiment with reference to FIG. 1. FIG. 1 is a schematic perspective view showing the secondary battery 1 of the first embodiment. As shown in FIG. 1, the secondary battery 1 includes an outer case 3 and an electrode assembly 8 provided inside the outer case 3. The outer case 3 has, for example, a cylindrical shape including a bottom wall 10 and a side wall 15. The outer case 3 includes an internal cavity (not shown) and has an aperture portion 9 formed at an upper surface. A lid member 7 is provided at the aperture portion 9. The outer case 3 and the lid member 7 are formed of a metal such as aluminum, an aluminum alloy, iron, copper, or stainless steel.

An outer peripheral edge of the aperture portion 9 of the outer case 3 and an outer peripheral edge of the lid member 7 are welded over an entire circumference. This welding uses, for example, laser light. The welding melts and solidifies the outer case 3 and the lid member 7 at the outer peripheral edge of the aperture portion 9 and the outer peripheral edge of the lid member 7, thereby forming a welded portion 37. The lid member 7 is fixed to the aperture portion 9 of the outer case 3 via the welded portion 37.

A gas vent valve 21 may be provided on a surface of the lid member 7 together with a sealing plate 19. Further, for example, a pair of positive external terminal 23a and negative external terminal 23b are attached to the surface of the lid member 7. Each of the external terminals 23a and 23b is electrically connected to the electrode assembly 8. A terminal insulator 35 may be provided between the external terminals 23a and 23b and the lid member 7 for maintaining insulation between them.

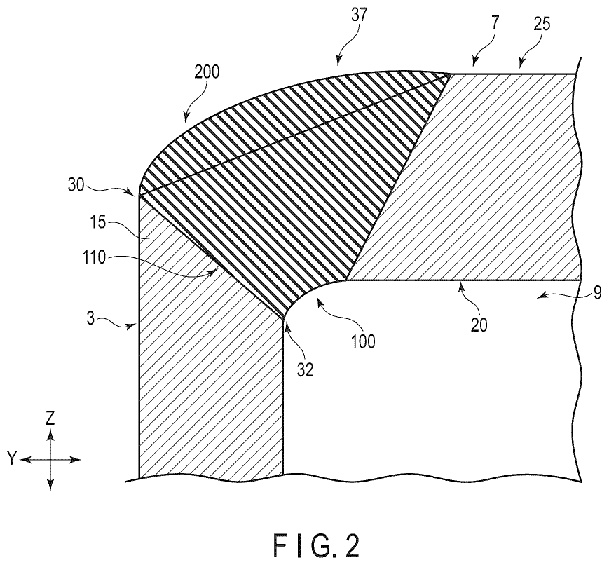

The following describes the welded portion 37 formed in the outer case 3 and the lid member 7 with reference to FIG. 2. FIG. 2 is a partial cross-sectional view of a YZ plane along line I-I in FIG. 1 (a plane along the housing direction of the electrode assembly 8) in the welded portion 37 of the secondary battery 1 of the first embodiment. As shown in FIG. 2, the welded portion 37 includes a first connecting portion 100 that connects the side wall 15 of the outer case 3 and a bottom surface 20 of the lid member 7 inside the outer case 3. The first connecting portion 100 is concave toward the outside of the outer case 3 at the welded portion 37.

This configuration allows dispersion of internal stress of the secondary battery 1 even when gas generated from the electrode assembly during charging and discharging accumulates inside the secondary battery 1 and increases internal pressure of the secondary battery 1. Further, the concave portion of the first connecting portion 100 is connected to a continuous arcuate shape of the side wall 15 of the outer case 3 and the bottom surface 20 of the lid member 7. This configuration can disperse internal stress of the secondary battery 1 over a wide area connecting the side wall 15 of the outer case 3 and the bottom surface 20 of the lid member 7. Accordingly, this configuration improves welding strength of the welded portion 37 between the aperture portion of the outer case 3 and the lid member 7 and further prevents breakage of the welded portion 37 caused by an increase in internal pressure of the secondary battery 1.

The welded portion 37 including the first connecting portion 100 can be formed by providing a gap between the aperture portion 9 of the outer case 3 and the lid member 7 before welding of the aperture portion 9 of the outer case 3 and the lid member 7. This configuration causes molten portions of the outer case 3 and the lid member 7 to flow into the gap during welding and solidify, thereby connecting the side wall 15 of the outer case 3 and the bottom surface 20 of the lid member 7. Specifically, when the thickness of the side wall 15 of the outer case 3 is approximately 0.4 mm or more and 0.7 mm or less, the gap is preferably approximately 0.2 mm. The gap is approximately 0.35 times or more and approximately 0.5 times or less the thickness of the side wall 15 of the outer case 3.

The welded portion 37 including the first connecting portion 100 is preferably provided over the entire circumference of the lid member 7. This configuration can prevent breakage of the welded portion 37 due to an increase in internal pressure of the secondary battery 1 over the entire circumference of the lid member 7.

As described above, the aperture portion 9 of the outer case 3 and the lid member 7 are preferably welded over the entire circumference in the secondary battery 1 of the present embodiment. The aperture portion 9 of the outer case 3 may have a rectangular shape including a long side 2 and a short side 4. The rectangular shape may lack corner portions at its four vertices.

When the aperture portion 9 of the outer case 3 has a rectangular shape, the welded portion 37 including the first connecting portion 100 is preferably provided over the entire circumference of the lid member 7. The welded portion 37 may be provided on at least one of the side walls 15 on the short side 4 side of the outer case 3. During welding of the aperture portion 9 of the outer case 3 and the lid member 7, fixtures may fix the side wall 15 on the long side 2 side of the outer case 3 from both sides in the X direction from the viewpoint of ease of welding. Under this condition, a gap can be easily provided between the short side 4 of the aperture portion 9 of the outer case 3 and the lid member 7.

Further, from the viewpoint of strength, the side walls 15 on the short side 4 side of the outer case 3 may be formed thicker than the side walls 15 on the long side 2 side of the outer case 3. As a result, welding of the side walls 15 on the short side 4 side of the outer case 3 and the lid member 7 may be more difficult than welding of the side wall 15 on the long side 2 side of the outer case 3 and the lid member 7. Accordingly, the welded portion 37 including the first connecting portion 100 is preferably provided on the side walls 15 on the short side 4 side to increase welding strength.

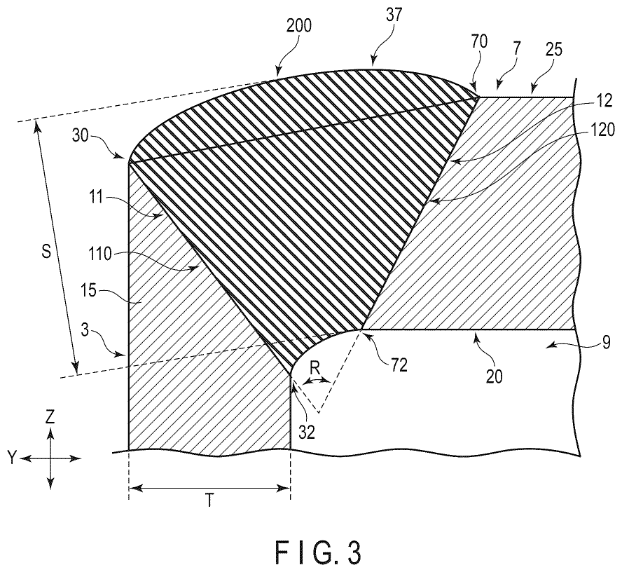

The following describes a welded portion 37 of the present embodiment with reference to FIG. 3. FIG. 3 is a partial cross-sectional view showing an angle formed between an interface of the side wall 15 of the outer case 3 and an interface of the lid member 7 in FIG. 2. As shown in FIG. 3, the welded portion 37 includes a first interface 11 with the side wall 15 of the outer case 3 and a second interface 12 with the lid member 7. The welded portion 37 includes a first virtual boundary line 110 that connects an outer case outer end portion 30 and an outer case inner end portion 32 at the first interface 11 and a second virtual boundary line 120 that connects a lid-member outer end portion 70 and a lid-member inner end portion 72 at the second interface 12. An angle R formed by the first virtual boundary line 110 and the second virtual boundary line 120 preferably measures 90° or less.

The definition of the first interface 11 and the second interface 12 uses cross-sectional observation obtained by a destructive test of the welded portion 37. The following describes a procedure of the cross-sectional observation by the destructive test of the welded portion 37. First, the procedure cuts the outer case 3 in the XY plane and divides the outer case 3 into an upper portion including the lid member 7 in the Z direction and a lower portion excluding the lid member 7 in the Z direction. Next, the procedure further cuts the upper portion including the lid member 7 in the Z direction in the periphery of the external terminal 23a at the XZ plane. This cutting divides the upper portion into a periphery portion of the external terminal 23a having an observation portion. Then, the procedure embeds this periphery portion of the external terminal 23a in resin. With the embedded state maintained, the procedure further cuts, in the YZ plane, a central portion of the external terminal 23a as the observation portion. The procedure polishes the obtained cut surface, and then performs etching using an etching solution, thereby obtaining a sample for cross-sectional observation. Observation of the obtained sample using an optical microscope defines a portion having a contrast different from contrast of the outer case 3 and the lid member 7 as the welded portion 37, defines a boundary between the outer case 3 and the welded portion 37 as the first interface 11, and defines a boundary between the lid member 7 and the welded portion 37 as the second interface 12.

The welded portion 37 has contrast different from contrast of the outer case 3 and the lid member 7 because the welded portion 37 forms through melting and solidification of the outer case 3 and the lid member 7 and has crystallinity different from crystallinity of the outer case 3 and the lid member 7.

The outer case outer end portion 30 is the outermost portion of the outer case 3 at the first interface 11. The outer case inner end portion 32 is the innermost portion of the outer case 3 at the first interface 11. The lid-member outer end portion 70 is the outermost portion of the lid member 7 at the second interface 12. The lid-member inner end portion 72 is the innermost portion of the lid member 7 at the second interface 12.

In the welded portion 37, the angle R formed by the first virtual boundary line 110 and the second virtual boundary line 120 preferably measures 90° or less. The angle R is defined as an angle formed at an intersection where an extension line of the first virtual boundary line 110 and an extension line of the second virtual boundary line 120 intersect each other.

When stress of the secondary battery 1 concentrates on the welded portion 37, the welded portion 37 may break at the first virtual boundary line 110 or the second virtual boundary line 120. Thus, the first virtual boundary line 110 and the second virtual boundary line 120 preferably maintain long lengths. The angle R of the welded portion 37 measuring 90° or less enables formation of the first virtual boundary line 110 and the second virtual boundary line 120 with long lengths. This configuration can prevent breakage of the welded portion 37 starting from the first virtual boundary line 110 or the second virtual boundary line 120 even when stress of the secondary battery 1 concentrates on the welded portion 37.

Further, the welded portion 37 of the present embodiment includes a second connecting portion 200 that connects the side wall 15 of the outer case 3 and an upper surface 25 of the lid member 7 outside the outer case 3. The second connecting portion 200 preferably is convex toward the outside of the outer case 3 at the welded portion 37. More preferably, the second connecting portion 200 is concave toward the inside of the outer case 3 at the welded portion 37.

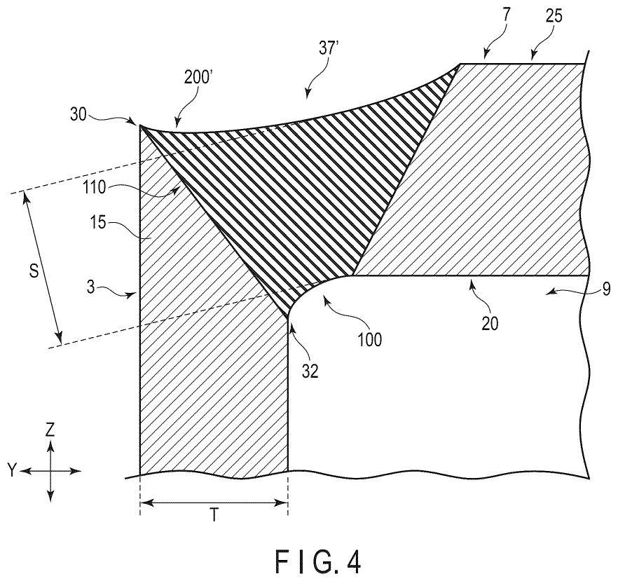

The following describes an effect of the second connecting portion 200 concave toward the inside of the outer case 3 at the welded portion 37 based on the comparison between FIG. 2 and FIG. 4. FIG. 4 is a partial cross-sectional view of a YZ plane along line I-I in FIG. 1 (a plane along the housing direction of the electrode assembly 8) in a modified example of the welded portion 37 (a welded portion 37′) of the secondary battery 1 of the first embodiment. As shown in FIG. 4, a second connecting portion 200′ of the welded portion 37′ is concave toward an inside of the outer case 3 at the welded portion 37′.

As shown in FIG. 4, the welded portion 37′ includes the first connecting portion 100. The first connecting portion 100 is concave toward the outside of the outer case 3 at the welded portion 37. This configuration can prevent breakage of the welded portion 37′ due to an increase in internal pressure of the secondary battery 1 by dispersing internal stress of the secondary battery 1 at the first connecting portion 100, and can prevent damage of the secondary battery 1. Further, the configuration in which the second connecting portion 200′ of the welded portion 37′ is concave toward the inside of the outer case 3 of the welded portion 37′ may reduce a possibility that the welded portion 37′ rises higher than the upper surface 25 of the lid member 7. Thus, the present embodiment can facilitate design such as a secondary battery module comprising a plurality of secondary batteries 1. When a design combines a plurality of secondary batteries 1 to design a secondary battery module, a connection member may connect the secondary batteries 1 to each other. In such a case, a configuration preferably maintains a maximum height of the secondary batteries 1 in the Z direction at a constant level. Thus, the configuration that prevents the welded portion 37′ from rising higher than the upper surface 25 of the lid member 7 can maintain the maximum height of the secondary battery 1 in the Z direction at a constant level and can facilitate connection between the secondary batteries 1.

Further, when a design combines a plurality of secondary batteries 1 to design a secondary battery module, a connection member may connect the secondary batteries 1 to each other. In this case, the configuration that prevents the welded portion 37′ from rising higher than the upper surface 25 of the lid member 7 can maintain a sufficient insulation distance between the connection member and the welded portion 37′, preventing short circuit between the connecting member and the welded portion 37′.

Further, as shown in FIG. 4, the second connecting portion 200′ of the welded portion 37′ is concave toward the inside of the outer case 3 at the welded portion 37′. Thus, this configuration can increase the length of the first virtual boundary line 110 that connects the outer case outer end portion 30 and the outer case inner end portion 32 at the first interface 11 and can sufficiently maintain strength of the welded portion 37′. When stress of the secondary battery 1 concentrates on the welded portion 37′, the welded portion 37′ may break at the first virtual boundary line 110 or the second virtual boundary line 120. Thus, the first virtual boundary line 110 and the second virtual boundary line 120 preferably have long lengths.

In addition, in the welded portion 37 and the welded portion 37′ of the present embodiment, a shortest distance S between the first connecting portion 100 and the second connecting portion 200 preferably exceeds a thickness T of the side wall 15 of the outer case 3. This configuration can further sufficiently maintain strength of the welded portion 37 and the welded portion 37′ and can prevent breakage of the welded portion 37 and the welded portion 37′ due to an increase in internal pressure of the secondary battery 1.

According to at least one embodiment of the secondary battery 1 described above, the welded portion 37 includes the first connecting portion 100 that connects the side wall 15 of the outer case 3 and the bottom surface 20 of the lid member 7 inside the outer case 3, and the first connecting portion 100 is concave toward the outer side of the outer case 3 at the welded portion 37. This configuration allows dispersion of internal stress of the secondary battery 1 even when gas generated from the electrode assembly 8 during charging and discharging accumulates inside the secondary battery 1 and increases internal pressure of the secondary battery 1. Further, the first connecting portion 100 is connected to a continuous arcuate shape of the side wall 15 of the outer case 3 and the bottom surface 20 of the lid member 7. This configuration can disperse internal stress of the secondary battery 1 over a wide area connecting the side wall 15 of the outer case 3 and the bottom surface 20 of the lid member 7. Thus, this configuration can prevent breakage of the welded portion 37 due to an increase in internal pressure of the secondary battery 1 and can prevent damage of the secondary battery 1. Thus, the present embodiment can provide the secondary battery 1 having excellent welding strength between the aperture portion of the outer case and the lid member.

### Second Embodiment

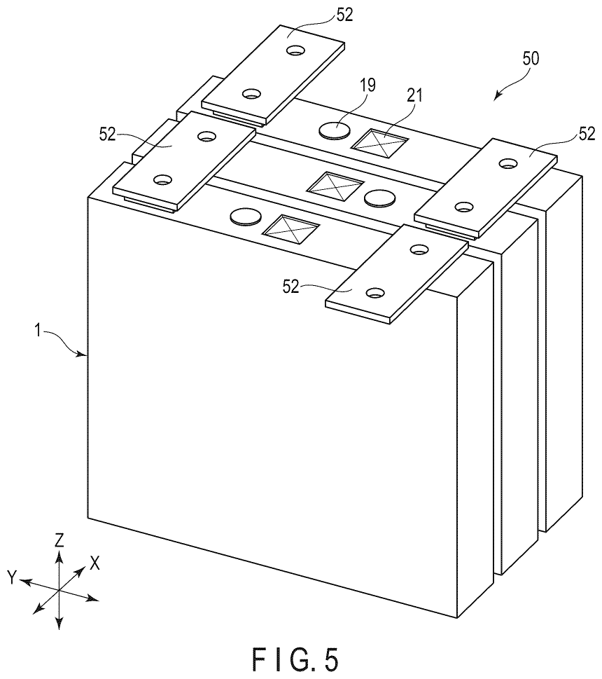

The following describes a secondary battery module 50 of the second embodiment with reference to FIG. 5. FIG. 5 is a schematic perspective view showing a secondary battery module 50 of the second embodiment. The secondary battery module 50 of the second embodiment includes the plurality of secondary batteries 1 according to the first embodiment. The secondary battery module 50 includes a connection member 52 such as a bus bar for electrically connecting the external terminals 23a and 23b. Connection of the secondary batteries 1 is not limited to a series connection and may be a parallel connection. Further, the plurality of secondary batteries 1 according to the first embodiment may be connected to each other. Alternatively, the secondary battery 1 and other secondary batteries different from the secondary battery 1 may be connected to each other.

The secondary battery module 50 of the present embodiment includes the plurality of secondary batteries 1 according to the first embodiment. That is, the first connecting portion 100 is concave toward the outside of the outer case 3 at the welded portion 37. Thus, this configuration allows dispersion of internal stress of the secondary battery 1 even when gas generated from the electrode assembly 8 during charging and discharging accumulates inside the secondary battery 1 and increases internal pressure of the secondary battery 1. Thus, this configuration can prevent breakage of the welded portion 37 due to an increase in internal pressure of the secondary battery 1 and can prevent damage of the secondary battery 1. Thus, the present embodiment can provide the secondary battery module 50 including the secondary battery 1 having excellent welding strength between the aperture portion of the outer case and the lid member.

While certain embodiments have been described, these embodiments have been presented by way of example only, and are not intended to limit the scope of the inventions. These embodiments can be implemented in various other forms, and various omissions, substitutions, and modifications can be made to the extent that they do not depart from the gist of the invention. These embodiments and variations thereof are included in the scope and gist of the invention as well as in the claims and their equivalents.

### EXAMPLE

The following describes examples. The present invention is not limited to the examples presented below unless the examples exceed the gist of the present invention.

### [Confirmation of Withstand-Pressure Effect of Welded Portion 37]

A withstand-pressure test confirmed a withstand-pressure effect of the welded portion 37 of the present embodiment. In manufacture of the secondary battery 1, welding over an entire circumference between the aperture portion 9 of the outer case 3 and the lid member 7 formed the welded portion 37. Further, a liquid injection hole was formed in the secondary battery 1, and water was injected into the inside of the secondary battery 1 through the liquid injection hole. Cross-sectional observation was conducted for the welded portion 37 when internal pressure of the secondary battery 1 reached 1.0 MPa. The cross-sectional observation used the cross-sectional observation procedure by the destructive test described above.

The following shows examples 1 to 6, comparative example 1, and comparative example 2.

### Example 1

The first connecting portion 100 was formed to be concave toward the outside of the outer case 3 at the welded portion 37, and an angle R at the welded portion 37 was set to 60°. Further, the second connecting portion 200 was formed to be convex toward the inside of the outer case 3 at the welded portion 37. Further, the welded portion 37 was formed such that the shortest distance S between the first connecting portion 100 and the second connecting portion 200 exceeds the thickness T of the side wall 15 of the outer case 3.

### Example 2

The angle R at the welded portion 37 was set to 30°. Other conditions were the same as those in example 1.

### Example 3

The angle R at the welded portion 37 was set to 90°. Other conditions were the same as those in example 1.

### Example 4

The angle R at the welded portion 37 was set to 120°. Other conditions were the same as those in example 1.

### Example 5

Further, the second connecting portion 200 was formed to be concave toward the inside of the outer case 3 at the welded portion 37. Other conditions were the same as those in example 1.

### Example 6

The welded portion 37 was formed such that the shortest distance S between the first connecting portion 100 and the second connecting portion 200 is shorter than the thickness T of the side wall 15 of the outer case 3. Other conditions were the same as those in example 1.

### Comparative Example 1

The first connecting portion 100 was not formed. The angle R at the welded portion 37 was set to 60°. Other conditions were the same as those in example 1.

### Comparative Example 2

The first connecting portion 100 was not formed. The second connecting portion 200 was formed to be concave toward the inside of the outer case 3 at the welded portion 37. Other conditions were the same as those in comparative example 1.

TABLE 1

| | | | | Relationship | |
|---|---|---|---|---|---|
| | First | | Second | between | Cross-section |
| | connecting | | connecting | distance S and | condition of |
| | portion | Angle R | portion | thickness T | welded portion |
| Embodiment 1 | Concave | 60 | Convex | S > T | Excellent |
| Embodiment 2 | Concave | 30 | Convex | S > T | Excellent |
| Embodiment 3 | Concave | 90 | Convex | S > T | Excellent |
| Embodiment 4 | Concave | 120 | Convex | S > T | Good |
| Embodiment 5 | Concave | 60 | Concave | S > T | Excellent |
| Embodiment 6 | Concave | 60 | Convex | S < T | Good |
| Comparative | — | 60 | Convex | — | Fair |
| example 1 | | | | | |
| Comparative | — | 60 | Concave | — | Fair |
| example 2 | | | | | |

Table 1 shows cross-sectional states of the welded portion 37 in the examples and the comparative examples. “Excellent” indicates that observation found no crack or break in the welded portion 37. “Good” indicates that observation found a minute crack in the welded portion 37. “Fair” indicates that observation found a crack in the welded portion 37 although the welded portion 37 did not break.

As shown in Table 1, the examples and the comparative examples are compared. The comparison confirmed that the configuration in which the first connecting portion 100 of the welded portion 37 is formed and the first connecting portion 100 is concave toward the outside of the outer case 3 can disperse internal stress even when internal pressure of the secondary battery 1 increases and can prevent breakage of the welded portion 37.

Further, the comparison among the examples 1 to 4 confirmed that the angle R of the welded portion 37 preferably measures 90° or less. The angle R of the welded portion 37 measuring 90° or less enables formation of the first virtual boundary line 110 and the second virtual boundary line 120 with long lengths in the welded portion 37. The comparison confirmed that this configuration can prevent breakage of the welded portion 37 starting from the first virtual boundary line 110 or the second virtual boundary line 120 even when stress of the secondary battery 1 concentrates on the welded portion 37.

Further, the comparison between the examples 1 and 6 confirmed that the shortest distance S between the first connecting portion 100 and the second connecting portion 200 preferably exceeds the thickness T of the side wall 15 of the outer case 3. The comparison confirmed that this configuration can sufficiently maintain strength of the welded portion 37 and can prevent breakage of the welded portion 37 due to an increase in internal pressure of the secondary battery 1.

The results of the withstand-pressure test described above are applied to the secondary battery 1 of the present embodiment. More specifically, the welded portion 37 includes the first connecting portion 100 that connects the side wall 15 of the outer case 3 and the bottom surface 20 of the lid member 7 inside the outer case 3. The first connecting portion 100 is concave toward the outside of the outer case 3 at the welded portion 37. This configuration allows dispersion of internal stress of the secondary battery 1 even when gas generated from the electrode assembly 8 during charging and discharging accumulates inside the secondary battery 1 during charging and discharging and increases internal pressure of the secondary battery 1. Further, the first connecting portion 100 is connected to a continuous arcuate shape of the side wall 15 of the outer case 3 and the bottom surface 20 of the lid member 7. This configuration can disperse internal stress of the secondary battery 1 over a wide area connecting the side wall 15 of the outer case 3 and the bottom surface 20 of the lid member 7. The first connecting portion 100 can disperse internal stress of the secondary battery 1. Thus, the configuration can prevent breakage of the welded portion 37 due to an increase in internal pressure of the secondary battery 1 and can prevent damage of the secondary battery 1. Thus, the present embodiment can provide the secondary battery 1 having excellent welding strength between the aperture portion of the outer case and the lid member.

What is claimed is:

1. A secondary battery comprising:
an outer case having a bottom wall, a side wall, and an aperture portion;
an electrode assembly housed in the outer case; and
a lid member disposed at the aperture portion of the outer case by a welded portion, wherein
the welded portion includes, in a cross section along a housing direction of the electrode assembly, a first connecting portion that connects the side wall and a bottom surface of the lid member inside the outer case, and
the first connecting portion is concave toward an outer case outside at the welded portion.

2. The secondary battery of claim 1, wherein
the aperture portion has a rectangular shape having long sides and short sides, and
the first connecting portion of the welded portion is provided on at least one of side walls on the short side of the outer case.

3. The secondary battery of claim 1, wherein
the welded portion includes, in the cross section along the housing direction of the electrode assembly, a first interface with the side wall of the outer case and a second interface with the lid member, and
an angle formed by a first virtual boundary line that connects an outer case outer end portion and an outer case inner end portion at the first interface and a second virtual boundary line that connects a lid-member outer end portion and a lid-member inner end portion at the second interface measures 90° or less.

4. The secondary battery of claim 1, wherein
the welded portion includes, in the cross section along the housing direction of the electrode assembly, a second connecting portion that connects the side wall and an upper surface of the lid member outside the outer case, and
the second connecting portion is concave toward an outer case inside at the welded portion.

5. The secondary battery of claim 1, wherein
the welded portion includes, in the cross section along the housing direction of the electrode assembly, a second connecting portion that connects the side wall and an upper surface of the lid member outside the outer case, and
a shortest distance between the first connecting portion and the second connecting portion exceeds a thickness of the side wall of the outer case.

6. A secondary battery module comprising:
the secondary battery of claim 1;
an external terminal provided on the secondary battery; and
a connection member electrically connected to the external terminal.
